(19) United States
(12) Patent Application Publication
(10) Pub. No.: US 2026/0147993 A1
(43) Pub. Date: May 28, 2026

(54) DETECTING AND ALERTING TO UNEXPECTED CHANGES IN LOG FORMATS OF SOFTWARE SYSTEMS

(71) Applicant: SAP SE, Walldorf (DE)

(72) Inventor: Hui Li, Shanghai (CN)

(21) Appl. No.: 18/958,175

(22) Filed: Nov. 25, 2024

(51) Int. Cl. G06F 40/194; G06F 11/34

(52) U.S. Cl. CPC G06F 40/194; G06F 11/3476; G06F 11/3688

(57) ABSTRACT

Methods, systems, and computer-readable storage media for receiving a source code file that records source code of a software system, determining, from the source code file, a set of log functions, each log function being executable to generate a log record representative of execution of the software system, generating, by prompting a LLM, a set of log function embeddings, each log function embedding being representative of a respective log function in the set of log functions, associating one or more parsers of a set of parsers with each log function, and in response to modification of the source code executing regression testing.

### BACKGROUND

Entities, such as commercial enterprises, use software systems to conduct operations. Example software systems can include, without limitation, enterprise resource management (ERP) systems, customer relationship management (CRM) systems, human capital management (HCM) systems, and the like. Software systems are deployed in cloud computing environments. Cloud computing can be described as Internet-based computing that provides shared computer processing resources, and data to computers and other devices on demand. As such, multiple entities, and multiple users within each entity, can interact with cloud-based software systems.

Cloud computing monitoring systems monitor operations of software systems in an effort to ensure adequate resources are provisioned and to alert to any issues that could or are affecting proper operation of the software systems. To this end, monitoring systems access logs that log various parameters representative of operation of software systems. Monitoring systems process log data in order to execute functionality, such as reporting, alerting, and the like.

### SUMMARY

Implementations of the present disclosure are directed to detecting unexpected changes in log formats of software systems. More particularly, implementations of the present disclosure are directed to a log format change detection system that leverages large language models (LLMs) to detect changes in log formats of software systems and to perform regression testing responsive to changes.

In some implementations, actions include receiving a source code file that records source code of a software system, determining, from the source code file, a set of log functions, each log function being executable to generate a log record representative of execution of the software system, generating, by prompting a LLM, a set of log function embeddings, each log function embedding being representative of a respective log function in the set of log functions, associating one or more parsers of a set of parsers with each log function, and in response to modification of the source code executing regression testing by identifying a second log function that includes one or more changes relative to a first log function, generating, by prompting the LLM, a first log based on the first log function and a second log based on the second log function, determining a parser associated with the first log function, providing first log data by parsing the first log using the parser and second log data by parsing the second log using the parser, and selectively determining regression of the source code based on the first log data and the second log data. Other implementations of this aspect include corresponding systems, apparatus, and computer programs, configured to perform the actions of the methods, encoded on computer storage devices.

These and other implementations can each optionally include one or more of the following features: determining, from the source code file, a set of log functions, each log function being executable to generate a log record representative of execution of the software system includes prompting the LLM to return the set of log function and, for each log function, a set of parameters that are recorded in a log record; selectively determining regression of the source code based on the first structured log data and the second first structured log data includes determining whether there is a difference between the first structured log data and the second structured log data; associating one or more parsers of a set of parsers with each log function includes generating, by prompting the LLM, a set of parser embeddings, each parser embedding being representative of a respective parser in a set of parsers, and associating one or more parsers of the set of parsers with each log function using the set of log function embeddings and the set of parser embeddings; each of the first log and the second log include synthetic log data that is generated by the LLM; each of the first log and the second log includes unstructured log data that is generated by the LLM; each of the first log data and the second log data includes structured log data; each parser parses unstructured data to provide structured data; and regression testing is executed at least partially in response to a pull request to merge changes to the source code within a code management system.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture of a log format change system in accordance with implementations of the present disclosure.

FIG. 3 depicts an example process that can be executed in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to detecting unexpected changes in log formats of software systems. More particularly, implementations of the present disclosure are directed to a log format change detection system that leverages large language models (LLMs) to detect changes in log formats of software systems and to perform regression testing responsive to changes.

Implementations can include actions of receiving a source code file that records source code of a software system, determining, from the source code file, a set of log functions, each log function being executable to generate a log record representative of execution of the software system, generating, by prompting a LLM, a set of log function embeddings, each log function embedding being representative of a respective log function in the set of log functions, associating one or more parsers of a set of parsers with each log function, and in response to modification of the source code executing regression testing by identifying a second log function that includes one or more changes relative to a first log function, generating, by prompting the LLM, a first log based on the first log function and a second log based on the second log function, determining a parser associated with the first log function, providing first log data by parsing the first log using the parser and second log data by parsing the second log using the parser, and selectively determining regression of the source code based on the first log data and the second log data.

To provide further context for implementations of the present disclosure, and as introduced above, monitoring systems monitor operations of software systems in an effort to ensure adequate resources are provisioned and to alert to any issues that could or are affecting proper operation of the software systems. More particularly, monitoring systems parse log data stored in logs that record various parameters representative of operation of software systems. Logs are typically provided as unstructured data (e.g., data that is not structured in a structured database format). Monitoring systems include parsers to parse logs into structured data and process the structure data for various monitoring functionality. For example, the structured data can be processed through alarm rules to selectively generate alarms, and/or can be used to populate reports.

However, in programming of software systems, there is nothing to restrict the output format of the logs that the software system generates. That is, developers are not restricted in defining log formats. As such, the log format can be changed, either purposefully or inadvertently, during development of the source code underlying the software system.

In many instances, the code management system, in which the source code is developed and maintained, and the monitoring system are independent of each other. Further, there is no regression test to ensure that the log format conforms to a format that the monitoring system expects to process. As a result, changes in the log format are often directly introduced into the production system. If there is an unexpected change in a log format, the log parsers of the monitoring system will not be able to correctly parse the unstructured data within the logs that are generated using the log format. This can result in multiple failures (e.g., in alarms and/or reporting), which can result in additional downstream failures. For example, alarms would not be triggered to alert unacceptable excursions of operating parameters, which can lead to increased latency and/or crashing of the software system. That is, absent being alerted to issues, operators and/or automated systems miss opportunities to implement interventions (the best intervention for a given moment) and the anomaly can spread more widely.

For purposes of non-limiting illustration, example source code of a software system can be considered, which includes a log print function to record the time cost to query an entity (e.g., the amount of time taken to query a data object). An example portion of source code can be provided as:

Listing 1: Example Portion of Source Code

```
class DBService{
...
  List query(...){
    ...
    log(“Querying the entity { } costs { } ms.”, entity , time)
  }
}
```

The example of Listing 1 includes a log function (log) that is executable to generate log records. In response to example operation of the software system, a record can be generated and stored in a log. A non-limiting, example record can be provided as:

Listing 2: Example Log Record

[DBService] Querying the entity User costs 789 ms.

In the example of Listing 2, the software system spent 789 ms (milliseconds) to query the entity (data object) User.

As noted above, the monitoring system includes a parser that can parse the record to provide structured data. In some examples, the parser is defined as a regular expression. Continuing with the non-limiting example above, a parser to extract the entity name and time cost can be provided as:

Listing 3: Example Parser (Regular Expression)

“\[DBService\] Querying the entity (?<entity>\w+) costs
(?<time>\d+) ms”

In this example, the monitoring system includes an alarm rule to send an alert when a series of high-cost queries (in terms of time cost) the User entity within a time window.

Continuing with the non-limiting example, in a new release of the software system, a log function is added (or modified) and can include:

Listing 4: Example Log Function

log(“Querying the entity { }, records:{ }, expand:{ }, time:{ }
ms”, entity, count, expand, time)

However, this introduces an unexpected change in the log format, as compared to the log function provided in the example of Listing 1. As such, the example parser of Listing 3 cannot parse records generated using the log function of Listing 4. Further, the previous alarm rule will no longer function, such that alerts will not be generated in response to conditions that are to be alerted for.

In view of the above context, implementations of the present disclosure provide a log format change detection system that leverages LLMs to detect changes in log formats of software systems and to perform regression testing in response to detected changes. As described in further detail herein, the log format change detection system protects the parsers, alarm rules, reporting, and the like of monitoring systems.

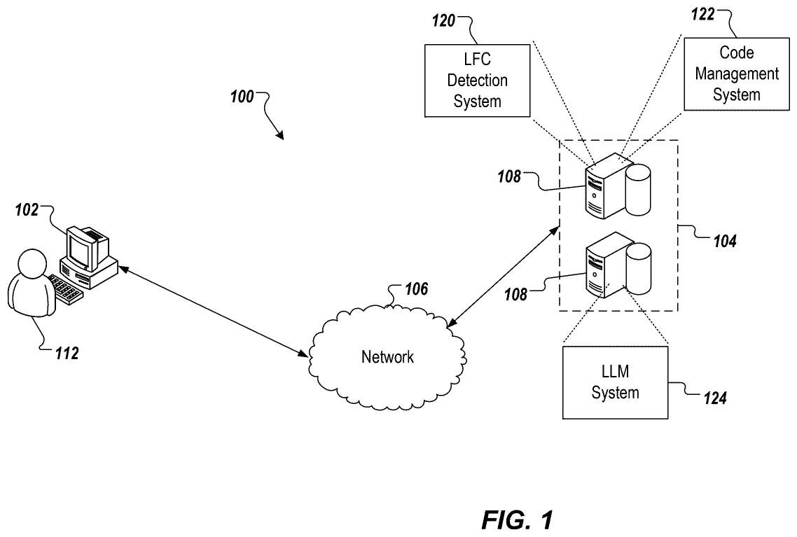

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a log format change (LFC) detection system 120 for detecting and regression testing of changes to log formats in software systems. For example, software systems can be developed and maintained in a code management system 122, which source code can be processed through the LFC detection system 120 in accordance with implementations of the present disclosure. As described in further detail herein, the LFC detection system 120 interacts with a LLM system 124 to detect changes to log formats and perform regression testing. In some implementations, the LLM system 124 is a third-party system that processes prompts through a LLM. Example LLMs include, without limitation, GPT-4 and LLaMa. Implementations of the present disclosure can be realized using any appropriate LLM.

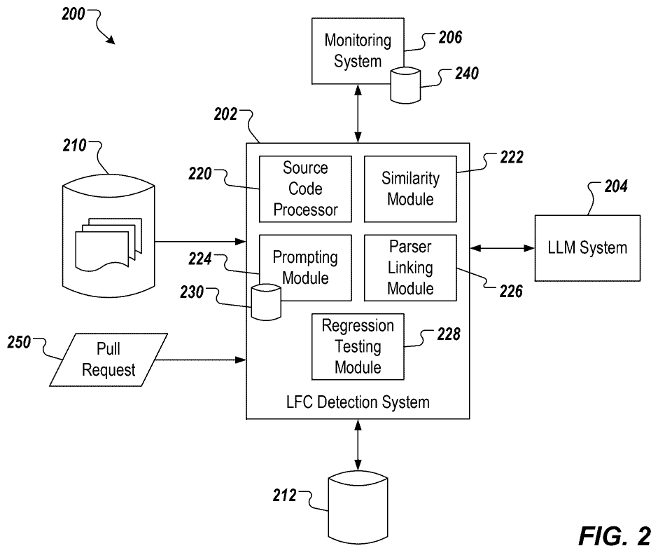

FIG. 2 depicts an example conceptual architecture 200 for LFC detection in accordance with implementations of the present disclosure. In the depicted example, the conceptual architecture 200 includes a LFC detection system 202 (e.g., the LFC detection system 120 of FIG. 1), a LLM system 204 (e.g., the LLM system 124 of FIG. 1), a monitoring system 206, a source code repository 210, and a data repository 212. In some examples, the source code repository 210 stores source code of software systems, the operation of which is monitored by the monitoring system 206. In some examples, the source code repository 210 is provided as part of (e.g., within) a code management system. In some examples, the LFC detection system 202 is provided as part of (e.g., within) the monitoring system 206. In the example of FIG. 2, the LFC detection system 202 includes a source code processor 220, a similarity module 222, a prompting module 224, a parser linking module 226, and a regression testing module 228. In some examples, the prompting module 224 uses prompt templates stored within a prompt template repository 230, as described in further detail herein.

In accordance with implementations of the present disclosure, source code files are processed by the LFC detection system 202 to use the LLM system 204 to extract (e.g., using the source code processor 220) the code lines containing log functions and types of parameters of the log functions. For example, the prompting module 224 can prompt the LLM system 204 to extract and return component, code content, parameter types, and location (e.g., uniform resource locator (URL)) for each log function in the source code. In some examples, the prompting module 224 uses an extraction prompt template that is stored in the prompt template repository 230 to generate an extraction prompt (e.g., by populating a placeholder of the extraction prompt template with a URL of the source code) and prompts the LLM system 204 using the extraction prompt. The LLM system 204 processes the extraction prompt to extract and return component, code content, parameter types, and location (e.g., uniform resource locator (URL)) for each log function in the source code.

For purposes of non-limiting illustration, an example portion of source code can include:

Listing 5: Example Portion of Source Code

```
class DBService{
  List query(...){
    ...
    log(“Querying the entity { } costs { } ms.”, entity , time)
  }
  void insert(...){
    ...
    log(“Inserting the entity { } costs { } ms.”, entity ,
time)
  }
  void update(...){
    ...
    log(“Updating the entity { } costs { } ms.”, entity , time)
  }
  void delete(...){
    ...
    log(“Deleting the entity { } costs { } ms.”, entity , time)
  }
}
```

In response to processing the example of Listing 5 through the LLM system 204, the following log function data can be provided:

TABLE 1
Example Log Function Data Extracted from Source Code

| | | Parameter | |
|---|---|---|---|
| Component | Code Content | Types | Location |
| DBService | log(“Querying the entity { } | [string, int] | http:// . . . / |
| | costs { } ms.”, entity, time) | | DBService.java#L101 |
| DBService | log(“Inserting the entity { } | [string, int] | http:// . . . / |
| | costs { } ms.”, entity, time) | | DBService.java#L235 |
| DBService | log(“Updating the entity { } | [string, int] | http:// . . . / |
| | costs { } ms.”, entity, time) | | DBService.java#L321 |
| DBService | log(“Deleting the entity { } costs | [string, int] | http:// . . . / |
| | { } ms.”, entity, time) | | DBService.java#L412 |
| . . . | . . . | . . . | . . . |

In some examples, the log function data, such as the example of Table 1, is stored in the data repository 212.

In some implementations, a log function embedding (E_{LF}) is generated for each log function record stored within the data repository 212. In general, an embedding can be described as a multi-dimensional, floating-point vector (e.g., an N-dimensional vector) that represents an entity (e.g., a log function record). In some examples, the prompting module 224 can prompt the LLM system 204 to return E_{LF} for each log function record (e.g., to provide a set of log function embeddings {E_{LF1}, . . . , E_{LFn}} a component). In some examples, the prompting module 224 uses a log function embedding prompt template that is stored in the prompt template repository 230 to generate a log function embedding prompt (e.g., by populating placeholders of the log function embedding prompt template with the log function data of the log function records) and prompts the LLM system 206 using the log function embedding prompt, which returns E_{LF} in response to the log function embedding prompt. In some examples, the data repository 212 can be updated to include E_{LF} for each log function record. For example:

TABLE 2
Example Log Function Data with Embeddings

| | | Parameter | | |
|---|---|---|---|---|
| Component | Code Content | Types | Location | E_{LF} |
| DBService | log(“Querying the | [string, int] | http:// . . . / | E_{LF, 1} |
| | entity { } costs { } | | DBService.java#L101 | |
| | ms.”, entity, time) | | | |
| DB Service | log(“Inserting the | [string, int] | http:// . . . / | E_{LF, 2} |
| | entity { } costs { } | | DBService.java#L235 | |
| | ms.”, entity, time) | | | |
| DBService | log(“Updating the | [string, int] | http:// . . . / | E_{LF, 3} |
| | entity { } costs { } | | DBService.java#L321 | |
| | ms.”, entity, time) | | | |
| DBService | log(“Deleting the | [string, int] | http:// . . . / | E_{LF, 4} |
| | entity { } costs { } | | DBService.java#L412 | |
| | ms.”, entity, time) | | | |
| . . . | . . . | . . . | . . . | |

The monitoring system 206 provides interfaces (e.g., web services application programming interface (API)) to expose definitions of parsers that are used to parse records of logs. In some implementations, the LFC detection system 202 (e.g., the parser linking module 226) retrieves definitions of each parser and identifies the code content (code lines) that generate log records that are parsed by the parser. In some examples, the LLM system 204 is used to generate embeddings that can be used to determine which parser corresponds to which code content. For example, a parser embedding (E_{P}) can be generated for each parser (e.g., to provide a set of parser embeddings {E_{P1}, . . . , E_{Pm}} for a component) and each parser embedding can be compared to each log function embedding to match a parser to each log function record stored in the data repository 212.

By way of non-limiting example, the example parser of Listing 3 can be considered. From the text “\ [DBService\],” it can be determined that the log is printed by the class DBService. A parser embedding (E_{P}) can be determined for the text “Querying the entity (?<entity>\w+) costs (?<time>\d+) ms” by the LLM system 204. In some examples, the prompting module 224 can prompt the LLM system 204 to return E_{P} for each parser. In some examples, the prompting module 224 uses a parser embedding prompt template that is stored in the prompt template repository 230 to generate a parser embedding prompt (e.g., by populating placeholders of the parser embedding prompt template with text of the parser) and prompts the LLM system 206 using the parser embedding prompt, which returns E_{P} in response to the parser embedding prompt.

In some implementations, each parser embedding of a component is compared to each log function embedding of the component to provide respective similarity scores (c_{P-LF}) in a set of similarity scores ({c_{P-LF1}, . . . , c_{P_LFm×n}}), each similarity score representing a degree of similarity between a parser embedding and a log function embedding. In some examples, the similarity scores for a component are calculated (e.g., by the similarity module 222) as a cosine correlation coefficient using the following example relationship:

$${c}_{P - L F i} = \frac{{\sum }_{q = 1}^{N} ( {E}_{P , q} \cdot {E}_{LF , q} )}{\sqrt{{\sum }_{q = 1}^{N} {( {E}_{P , q} )}^{2}} \cdot \sqrt{{\sum }_{q = 1}^{N} {( {E}_{L F , q} )}^{2}}}$$

where N is the dimension of the embedding, E_{P,q} is the q^{th} element of E_{P}, and E_{LF,q} is the q^{th} element of E_{LF}, and c_{P-LFi} is the i^{th} similarity score in {c_{P-LF1}, . . . , c_{P_LFm×n}}. For each parser, a maximum similarity score is determined and the parser is associated with the log function record corresponding to the log function embedding that resulted in the maximum similarity score. For example, a sub-set of similarity scores {c_{P-LF1}, c_{P-LF2}, c_{P-LF3}} can be determined for respective embedding pairs [E_{P1}, E_{LF1}], [E_{P1}, E_{LF2}], and [E_{P1}, E_{LF3}]. It can be determined that c_{P-LF2} is the maximum similarity score in the sub-set {c_{P-LF1}, c_{P-LF2}, c_{P-LF3}}. Consequently, and within the data repository 212, the parser that E_{P1} was generated from is associated with the log function record that E_{LF2} was generated from. The data repository 212 can be updated to record the associations between log function records and parsers (e.g., by parser identifier (ID)). For example:

TABLE 3
Example Log Function Data with Parsers

| | | | | | |
|---|---|---|---|---|---|
| | | Parameter | | | |
| Component | Code Content | Types | . . . | E_{LF} | Parser |

| | | | | |
|---|---|---|---|---|
| DBService | log(“Querying the | [string, | E_{LF, 1} | parser_123 |
| | entity { } costs { } | int] | | |
| | ms.”, entity, | | | |
| | time) | | | |
| DBService | log(“Inserting the | [string, | E_{LF, 2} | parser_789, |
| | entity { } costs { } | int] | | parser_323 |
| | ms.”, entity, | | | |
| | time) | | | |
| DBService | log(“Updating the | [string, | E_{LF, 3} | parser_457 |
| | entity { } costs { } | int] | | |
| | ms.”, entity, | | | |
| | time) | | | |
| DBService | log(“Deleting the | [string, | E_{LF, 4} | parser_239, |
| | entity { } costs { } | int] | | parser_223 |
| | ms.”, entity, | | | |
| | time) | | | |
| . . . | . . . | . . . | | |

In some instances, source code is updated (e.g., as part of a development lifecycle). For example, changes can be made to source code within the code management systems. In some examples, changes are merged into a code base through pull requests. For example, after modifying code, a developer can issue a pull request (such as a pull request 250 of FIG. 2) to have changes merged into the code base.

In some implementations, it can be determined whether the pull request is representative of code lines that have been changed and that include log functions. If the code lines that have been changed include log functions, regression testing can be performed, as described in further detail herein. For example, code management systems (e.g., Git, SVN) determine which code lines have been changed by comparing new versions of code with old versions of code, and can give you a mapping of the old lines to the new ones. It is already known in the database, which old lines of code print logs. Accordingly, once the code has been changed and a pull request has been submitted, the code management system can provide a notification as to changed code. The changed code can be compared to the code of print logs in the database to determine whether changes impact log functions.

For example, and continuing with the non-limiting examples above, the example portion of source code of Listing 1 can be changed to be provided as:

Listing 6: Example Portion of Source Code

```
class DBService{
...
  List query(...){
    ...
    log(“Querying the entity { }, records:{ }, expand:{ }, time:{ }
ms”, entity, count, expand, time)
  }
}
```

In the example of Listing 6, the log function “log (“Querying the entity { } costs { } ms.”, entity, time)” (e.g., v1) has been changed to the log function “log (“Querying the entity { }, records: { }, expand: { }, time: { } ms”, entity, count, expand, time)” (e.g., v2). In some examples, the LLM system 204 can be used to re-parse the modified code file to return the log print functions and parameter types of the new code. For example, in the example of Listing 6, the LLM system 204 can be prompted to parse the file and find that the new code line's log print function is “log (“Querying the entity { }, records: { }, expand: { }, time: { } ms”, entity, count, expand, time)” with arguments [string, int, int, int].

In some implementations, regression testing can include generating a first synthetic log for the old log function (e.g., v1) and a second synthetic log for the new log function (e.g., v2) using the LLM system 204, using the parser(s) associated with the old log function to parse the first synthetic log and the second synthetic log to provide first parsing results and second parsing results, respectively. In some examples, the first parsing results and the second parsing results are compared to determine whether there is any difference therebetween. If there is a difference, there is an unexpected change in the log format of the source code and an error is flagged. For example, the code management system blocks merging of the source code and issues an alert.

In further detail, the LLM system 204 is prompted to generate the first synthetic log for the old log function (e.g., v1) and the second synthetic log for the new log function (e.g., v2), each of the first synthetic log and the second synthetic log being populated with synthetic data (non-realworld data). In some examples, the prompting module 224 can prompt the LLM system 204 to return a synthetic log for each log function. In some examples, the prompting module 224 uses a log data prompt template that is stored in the prompt template repository 230 to generate a log data prompt (e.g., by populating placeholders of the log data prompt template with text of the respective log function) and prompts the LLM system 206 using the log data prompt, which returns the synthetic log for the respective log function in response to the log data prompt. For example, synthetic logs can be returned from the LLM system 204 using the following example prompt:

```
Suppose you are a software development expert. Some enginneer
has modified the log output function of the code.
The first original log output function was
‘‘‘
// The content of the first output function
‘‘‘
with parameter types {parameter types of first function}
Now the second modified log output function is
‘‘‘
// The contents of the second output function
‘‘‘
with parameter types {parameter types of second function}
Please generate 100 paris of synthetic logs for each of the
first and second logging functions to test if the log parser
is working properly. Please return them in JSON array format
as follows
‘‘‘
[
  {“first”: “first log example 1”, “second″: “second log
example 1”},
  {“first”: “first log example 2”, “second”: “second log
example 2”},
    ....
]
‘‘‘
For example, suppose the first log output function was
‘‘‘
log(“Querying the entity { } costs { } ms.”, entity , time)
‘‘‘
with parameter types [string, int]
The second log output function is
‘‘‘
log(“Querying the entity { }, records:{ }, expand:{ }, time:{ }
ms”, entity, count, expand, time)
‘‘‘
with parameter types [string, int, int, int]
You can return the following synthetic log
‘‘‘
  [
    { “first”: “Querying the entity abc costs 889 ms”,
    “second″: ”Querying the entity abc, records: 444, expand:
783, time: 889 ms” },
    { “first”: “Querying the entity yy(>! @$uy costs 98763 ms”,
      “second”: “Querying the entity yy(>! @$uy, records:
345343, expand: 98766, time: 98763 ms”},
...
]
‘‘‘
```

In some implementations, synthetic logs can be generated programmatically. For example, the old log function and the new log function are known, as discussed above, as well as the format of their arguments. For example:

TABLE 4
Example Old and New Log Functions

| | Old Version | New Version |
|---|---|---|
| log function | log(“Querying the entity { } | [string, int] |
| | costs { } ms.”, entity, | |
| | time) | |
| parameter types | log(“Querying the entity | [string, int, expand, time] |
| | { }, records: { }, expand: { }, | |
| | time: { } ms”, entity, count, | |
| | expand, time) | |

In some examples, synthetic logs can be generated by generating random strings or numbers depending on parameter types. For example, and with reference to the example of Table 4, the variable ‘entity’ can be randomly generated as “abcdfeer,” the variable ‘time’ as 3453, the variable ‘count’ as 7769, and the variable ‘expand’ as 324. The following example synthetic logs can be provided:

TABLE 5
Example Synthetic Logs

| First Synthetic Log | Second Synthetic Log |
|---|---|
| [DBService] Querying the entity | [DBService] Querying the entity |
| abcdfeer costs 3453 ms | abcdfeer, records: 7769, expand: |
| | 324, time: 3453 ms |

Repeating this, many pairs of logs can be generated.

By way of non-limiting example, example synthetic logs can be provided as (Prefix the class name “DBService”):

TABLE 6
Example Synthetic Logs

| First Synthetic Log | Second Synthetic Log |
|---|---|
| (from old log function (v1)) | (from new log function (v2)) |
| [DBService] Querying the entity | [DBService] Querying the entity abc, |
| abc costs 889 ms | records: 444, expand: 783, time: 889 |
| | ms |
| [DBService] Querying the entity | [DBService] Querying the entity |
| HFJJKG costs 43523523 ms | HFJJKG, records: 8425231, expand: |
| | 5645, time: 43523523 ms |
| [DBService] Querying the entity | [DBService] Querying the entity |
| yy(>!@$uy costs 98763 ms | yy(>!@$uy, records: 345343, |
| | expand: 98766, time: 98763 ms |
| . . . | . . . |

In some implementations, the parser(s) associated with the old log function is determined. For example, and with reference to the non-limiting example of Table 3, it can be determined that parser_123 is to be used. In some examples, the parser is used to parse records of each of the first synthetic log and the second synthetic log to provide first structured log data and second structured log data, respectively. The first structured log data and the second structured log data are compared to determine whether there is any difference therebetween. For example, and with references to the examples herein, the parser of Listing 3 can be used to parse the synthetic logs of Table 6 to provide the following comparison result:

TABLE 7
Parsing Results

| Parsed First Synthetic Log | Parsed Second Synthetic Log |
|---|---|
| entity: abc | entity: NULL |
| time: 889 | time: NULL |
| entity: HFJJKG | entity: NULL |
| time: 43523523 | time: NULL |
| entity: NULL | entity: NULL |
| time: NULL | time: NULL |
| . . . | . . . |

It can be seen that the parsing results of the old and new logs are inconsistent. In this case, the log format was modified in an unintended way and the code cannot be merged.

If there is no difference between the first structured log data and the second structured log data, the pull request is executed and the source code is merged. In some examples, log function data (e.g., in Table 1, Table 2, Table 3) is updated. If there is a difference, there is an unexpected change in the log format of the source code and an error is flagged. For example, the code management system blocks merging of the source code and issues an alert. In some examples, the error can be resolved to enable merging of the source code. For example, and with reference to the non-limiting examples above, the log function of Listing 6 can be modified to:

Listing 7: Example Modified Log Function

log(“Querying the entity { } costs { } ms, records: { }, expand:
{ } ”, entity , time, count, expand)

In some examples, after the log function is modified, another pull request can be issued. In response to the pull request, regression testing can be conducted again to confirm whether the modified log function enable proper parsing by the parser.

Continuing with the non-limiting examples above, the old and new log pairs are generated as follows (prefix the class name “DBService”):

TABLE 8
Example Synthetic Logs

| First Synthetic Log | Second Synthetic Log |
|---|---|
| (from old log function (v1)) | (from new log function (v2)) |
| [DBService] Querying the entity | [DBService] Querying the entity abc, |
| abc costs 889 ms | costs 889 ms, records: 444, expand: |
| | 783 |
| [DBService] Querying the entity | [DBService] Querying the entity |
| HFJJKG costs 43523523 ms | HFJJKG costs 43523523 ms, |
| | records: 8425231, expand: 5645 |
| [DBService] Querying the entity | [DBService] Querying the entity |
| yy(>!@$uy costs 98763 ms | yy(>!@$uy costs 98763 ms, records: |
| | 345343, expand: 98766 |
| . . . | . . . |

The parser of Listing 3 can be to parse synthetic log pairs of Table 8 to provide:

TABLE 9
Parsing Results

| Parsing result of First Synthetic | Parsing result of Second Synthetic |
|---|---|
| Log | Log |
| entity: abc | entity: abc |
| time: 889 | time: 889 |
| entity: HFJJKG | entity: HFJJKG |
| time: 43523523 | time: 43523523 |
| entity: NULL | entity: NULL |
| time: NULL | time: NULL |
| . . . | . . . |

It can be seen that the parsing results of the old and new logs are consistent and the code can be merged.

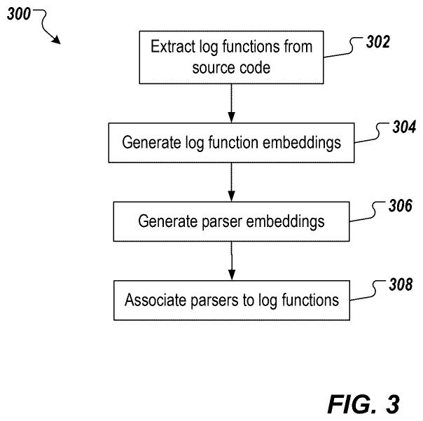

FIG. 3 depicts an example process 300 that can be executed in accordance with implementations of the present disclosure. In some examples, the example process 300 is provided using one or more computer-executable programs executed by one or more computing devices.

Log functions are extracted from source code (302). For example, and as described in detail herein, the prompting module 224 can prompt the LLM system 204 extract and return component, code content, parameter types, and location (e.g., uniform resource locator (URL)) for each log function in the source code. Log function embeddings are generated (304). For example, and as described in detail herein, the prompting module 224 uses a log function embedding prompt template that is stored in the prompt template repository 230 to generate a log function embedding prompt (e.g., by populating placeholders of the log function embedding prompt template with the log function data of the log function records) and prompts the LLM system 206 using the log function embedding prompt, which returns E_{LF} in response to the log function embedding prompt. In some examples, the data repository 212 can be updated to include E_{LF} for each log function record.

Parser embeddings are generated (306). For example, and as described in detail herein, the prompting module 224 uses a parser embedding prompt template that is stored in the prompt template repository 230 to generate a parser embedding prompt (e.g., by populating placeholders of the parser embedding prompt template with text of the parser) and prompts the LLM system 206 using the parser embedding prompt, which returns E_{P} in response to the parser embedding prompt. Parsers are associated with log functions (308). For example, and as described in detail herein, each parser embedding of a component is compared to each log function embedding of the component to provide respective similarity scores (c_{P-LF}) in a set of similarity scores ({c_{P-LF1}, . . . , c_{P_LFm×n}}), each similarity score representing a degree of similarity between a parser embedding and a log function embedding. A parser is associated with a log function based on similarity score.

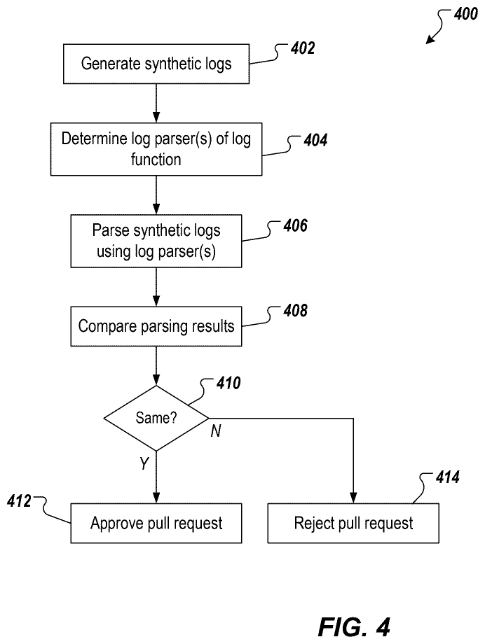

FIG. 4 depicts an example process 400 that can be executed in accordance with implementations of the present disclosure. In some examples, the example process 400 is provided using one or more computer-executable programs executed by one or more computing devices.

Synthetic logs are generated (402). For example, and as described in detail herein, the LLM system 204 is prompted to generate the first synthetic log for the old log function (e.g., v1) and the second synthetic log for the new log function (e.g., v2), each of the first synthetic log and the second synthetic log being populated with synthetic data (non-realworld data). In some examples, the prompting module 224 can prompt the LLM system 204 to return a synthetic for each log function. One or more parsers are identified for the log function (404). For example, and as described in detail herein, and with reference to the non-limiting example of Table 3, it can be determined that parser_123 is to be used.

The synthetic logs are parsed using the one or more log parsers (406), parsing results are compared (408) and it is determined whether the parsing results are the same (410). For example, and as described in detail herein, the parser is used to parse records of each of the first synthetic log and the second synthetic log to provide first structured log data and second structured log data, respectively. The first structured log data and the second structured log data are compared to determine whether there is any difference therebetween. If the parsing results are the same, the pull request is approved (412). For example, and as described in detail herein, changes to the source code are merged by the code management system (e.g., the code management system 122 of FIG. 1). If the parsing results are not the same, the pull request is rejected (414). For example, and as described in detail herein, the code management system blocks merging of the source code and issues an alert. In some examples, the error can be resolved (e.g., by a developer) to enable merging of the source code.

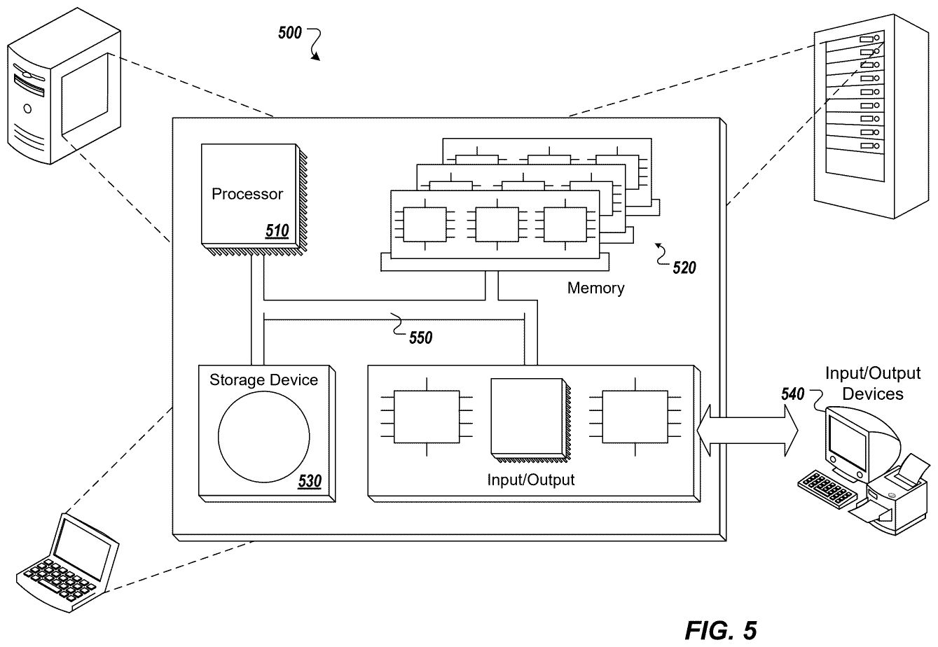

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for detecting log format changes in source code, the method being executed by one or more processors and comprising:
receiving a source code file that records source code of a software system;
determining, from the source code file, a set of log functions, each log function being executable to generate a log record representative of execution of the software system;
generating, by prompting a large language model (LLM), a set of log function embeddings, each log function embedding being representative of a respective log function in the set of log functions;
associating one or more parsers of a set of parsers with each log function; and
in response to modification of the source code executing regression testing comprising:
identifying a second log function that comprises one or more changes relative to a first log function,
generating, by prompting the LLM, a first log based on the first log function and a second log based on the second log function,
determining a parser associated with the first log function,
providing first log data by parsing the first log using the parser and second log data by parsing the second log using the parser, and
selectively determining regression of the source code based on the first log data and the second log data.

2. The method of claim 1, wherein determining, from the source code file, a set of log functions, each log function being executable to generate a log record representative of execution of the software system comprises prompting the LLM to return the set of log function and, for each log function, a set of parameters that are recorded in a log record.

3. The method of claim 1, wherein selectively determining regression of the source code based on the first structured log data and the second first structured log data comprises determining whether there is a difference between the first structured log data and the second structured log data.

4. The method of claim 1, wherein associating one or more parsers of a set of parsers with each log function comprises:
generating, by prompting the LLM, a set of parser embeddings, each parser embedding being representative of a respective parser in a set of parsers; and
associating one or more parsers of the set of parsers with each log function using the set of log function embeddings and the set of parser embeddings.

5. The method of claim 1, wherein each of the first log and the second log comprise synthetic log data that is generated by the LLM.

6. The method of claim 1, wherein each of the first log and the second log comprises unstructured log data that is generated by the LLM.

7. The method of claim 1, wherein each of the first log data and the second log data comprises structured log data.

8. The method of claim 1, wherein each parser parses unstructured data to provide structured data.

9. The method of claim 1, wherein regression testing is executed at least partially in response to a pull request to merge changes to the source code within a code management system.

10. A non-transitory computer-readable storage medium coupled to one or more processors and having instructions stored thereon which, when executed by the one or more processors, cause the one or more processors to perform operations for detecting log format changes in source code, the operations comprising:
receiving a source code file that records source code of a software system;
determining, from the source code file, a set of log functions, each log function being executable to generate a log record representative of execution of the software system;
generating, by prompting a large language model (LLM), a set of log function embeddings, each log function embedding being representative of a respective log function in the set of log functions;
associating one or more parsers of a set of parsers with each log function; and
in response to modification of the source code executing regression testing comprising:
identifying a second log function that comprises one or more changes relative to a first log function,
generating, by prompting the LLM, a first log based on the first log function and a second log based on the second log function,
determining a parser associated with the first log function,
providing first log data by parsing the first log using the parser and second log data by parsing the second log using the parser, and
selectively determining regression of the source code based on the first log data and the second log data.

11. The non-transitory computer-readable storage medium of claim 10, wherein determining, from the source code file, a set of log functions, each log function being executable to generate a log record representative of execution of the software system comprises prompting the LLM to return the set of log function and, for each log function, a set of parameters that are recorded in a log record.

12. The non-transitory computer-readable storage medium of claim 10, wherein selectively determining regression of the source code based on the first structured log data and the second first structured log data comprises determining whether there is a difference between the first structured log data and the second structured log data.

13. The non-transitory computer-readable storage medium of claim 10, wherein associating one or more parsers of a set of parsers with each log function comprises:
generating, by prompting the LLM, a set of parser embeddings, each parser embedding being representative of a respective parser in a set of parsers; and
associating one or more parsers of the set of parsers with each log function using the set of log function embeddings and the set of parser embeddings.

14. The non-transitory computer-readable storage medium of claim 10, wherein each of the first log and the second log comprises synthetic log data that is generated by the LLM.

15. A system, comprising:
a computing device; and
a computer-readable storage device coupled to the computing device and having instructions stored thereon which, when executed by the computing device, cause the computing device to perform operations for detecting log format changes in source code, the operations comprising:
receiving a source code file that records source code of a software system;
determining, from the source code file, a set of log functions, each log function being executable to generate a log record representative of execution of the software system;
generating, by prompting a large language model (LLM), a set of log function embeddings, each log function embedding being representative of a respective log function in the set of log functions;
associating one or more parsers of a set of parsers with each log function; and
in response to modification of the source code executing regression testing comprising:
identifying a second log function that comprises one or more changes relative to a first log function,
generating, by prompting the LLM, a first log based on the first log function and a second log based on the second log function,
determining a parser associated with the first log function,
providing first log data by parsing the first log using the parser and second log data by parsing the second log using the parser, and
selectively determining regression of the source code based on the first log data and the second log data.

16. The system of claim 15, wherein determining, from the source code file, a set of log functions, each log function being executable to generate a log record representative of execution of the software system comprises prompting the LLM to return the set of log function and, for each log function, a set of parameters that are recorded in a log record.

17. The system of claim 15, wherein selectively determining regression of the source code based on the first structured log data and the second first structured log data comprises determining whether there is a difference between the first structured log data and the second structured log data.

18. The system of claim 15, wherein associating one or more parsers of a set of parsers with each log function comprises:
generating, by prompting the LLM, a set of parser embeddings, each parser embedding being representative of a respective parser in a set of parsers; and
associating one or more parsers of the set of parsers with each log function using the set of log function embeddings and the set of parser embeddings.

19. The system of claim 15, wherein each of the first log and the second log comprises synthetic log data that is generated by the LLM.

20. The system of claim 15, wherein each of the first log and the second log comprises unstructured log data that is generated by the LLM.
